(19) United States
(12) Patent Application Publication
(10) Pub. No.: US 2025/0087193 A1
(43) Pub. Date: Mar. 13, 2025

(54) Artificial Aging of Electromagnetic Musical Instrument Pickups

(71) Applicant: Michael Peter Shaw, Victoria (CA)

(72) Inventor: Michael Peter Shaw, Victoria (CA)

(21) Appl. No.: 18/464,266

(22) Filed: Sep. 11, 2023

(51) Int. Cl. G10H 3/18

(52) U.S. Cl. CPC G10H 3/181; G10H 2220/461

(57) ABSTRACT

This novel process results in the permanent alteration of the sound of an electromagnetic pickup for musical instruments by running an audio signal of a certain voltage through the pickup for an extended period of time. This results in a change to the sound produced by the pickup that is considered to be more pleasant and desirable by musicians.

### REFERENCE TO RELATED APPLICATIONS

This application is related to the provision application 63/375,854 that was filed on Sep. 16, 2022.

### BACKGROUND OF THE INVENTION

This invention relates to musical instruments. More specifically, electromagnetic pickups (“pickup” or “pickups”) that are used in musical instruments to convert vibrations into electronic signals.

For example, old electric guitars are sought after not only due to their rarity and history, but also because players prefer how they sound when compared to new guitars.

As the pickup ages, the sound it produces changes.

There is considerable interest by players in having musical instruments that look and sound older than they are.

This application described the physical process to take new pickups and artificially change their sound to approximate that of old pickups.

### SUMMARY OF THE INVENTION

In their normal mode of use, a pickup uses a coil of wire placed in close proximity to a magnet to convert the vibration of instrument strings into an alternating electrical voltage, otherwise known as a signal. They were never designed or contemplated to run in reverse where an alternating electrical voltage or signal is run into the pickup.

This application comprises a novel process to artificially age the sound of pickups by attaching the pickup to the output of an audio frequency amplifier (“amplifier”) that is running a broad frequency AC audio signal, such as pink noise.

The amplifier should be capable of applying an AC voltage of between 2 and 70 volts across the pickup for more than 10 minutes. In tests, it was found that 70 volt or 100 volt Constant Voltage-type amplifiers are capable of doing this.

The invented process involves attaching the wires of the pickup to the amplifier's output, turning on the amplifier and the audio source, then adjusting the amplifier's output up to the desired voltage across the pickup.

The recommended voltage across the pickups for average aging is 60 volts with a processing time of 24 hours. However, different voltages and times can be used depending on the resulting sound characteristics desired by the user and the design of the pickup being processed. Personal safety measures should be taken if running more than 42 volts across the pickup.

The pickup can then be used for its intended purpose in a musical instrument.

The result of the process is a discernible change in the sound of the pickup, which can be described as having a moderating effect so that the sound of the higher frequencies are less shrill and the lower frequencies are more focused and defined.

In short, the process results in a pickup that sounds more pleasing to the ear and more like an older pickup.

### BRIEF DESCRIPTION OF DRAWINGS

The terminology used herein is for the purpose of describing particular embodiments only and is not intended to be limiting of the invented process.

The process will now be described by referencing the appended FIGURE (FIG. 1).

FIG. 1 depicts a simple diagram of the devices needed to perform the process that is the subject of this application.

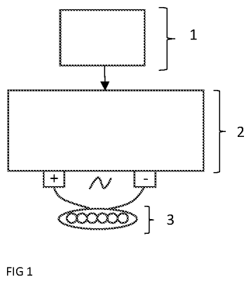

1 is an audio source, which could be but is not limited to, a CD player, computer, cell phone or other device capable of playing broad frequency audio, such as pink noise. 1 provides the source signal to 2.
2 is the amplifier that is capable of driving the pickup load, which can be a 70 volt or 100 volt Constant Voltage-type amplifier.
3 is the pickup that is intended to be artificially aged, attached to the amplifier output connection through the pickup lead wires.

What is claimed is:

1. A process that permanently alters the sound produced by electromagnetic pickups of musical instruments, where the process comprises of:
a. Sending an audio signal, via an audio frequency amplifier, into the electromagnetic pickup; and
b. Continuing to run the signal into the electromagnetic pickup for more than 10 minutes.
